(19) United States
(12) Patent Application Publication
(10) Pub. No.: US 2004/0143547 A1
(43) Pub. Date: Jul. 22, 2004

(54) Automated accounts payable using image typing and type specific processing

(76) Inventor: Dean Mersky, Waxhaw, NC (US)

Correspondence Address: Rutan & Tucker LLP, Suite 1400, 611 Anton Blvd., Costa Mesa, CA, 92626, US

(21) Appl. No.: 10/612,362

(22) Filed: Jul. 1, 2003

Related U.S. Application Data
(60) Provisional application No. 60/393,673, filed on Jul. 2, 2002.

(51) Int. Cl. G06F 17/60

(52) U.S. Cl. 705/40

(57) ABSTRACT

Systems and methods adapted to facilitate automated processing of paper documents, particularly accounts payable documents, and to facilitate automated payment of processed documents, particularly billing invoices reconciled against processed purchase orders and shipping invoices.

This application claims the benefit of U.S. provisional application No. 60/393,673 incorporated herein by reference in its entirety.

### FIELD OF THE INVENTION

The field of the invention is document imaging and processing.

### BACKGROUND OF THE INVENTION

All businesses are faced with the management required by accounts payable. This management, which is non revenue producing, can present an ominous task, the extent of which will be dependent upon the number of vendors, purchase orders, invoices, items per invoice, shipping mistakes, and billing mistakes. Normally, all records are originated, reconciled, and archived on paper. Occasionally, some may hand enter important information found on paper to a desktop, still, a very hands-on intensive task.

Although electronic billing and payment (EBP) systems could address and eliminate these tasks, the difficulty associated with setup discourages most small to medium sized companies from attempting the establishment of EBP integration.

### SUMMARY OF THE INVENTION

The present invention is directed to systems and methods for document information extraction, particularly as used to automate accounts payable processing. More particularly, an embodiment of the present invention is able to convert paper to digital information for auto reconciliation, and payment.

It is contemplated that many businesses and individuals would benefit from being able to decrease the amount of time spent reviewing and deriving data from paper documents. To many people it would be ideal if all standard types of data were communicated directly from one entity's computer systems to those of all other entities it has dealings with. However, for the foreseeable future that amount of standardization and automation of data transfer is not likely to be achieved. As such, businesses and individuals will likely to continue large amounts of data via paper documents as well as free-form and non-standard electronic documents.

A preferred system for document information extraction (SDIE) will preferably minimize the amount of time required for a person to handle/review a document in order to extract the data the document contains. At a high level, such a system will simply accept documents and/or document images and handle them appropriately such that any data contained in the documents is passed on to other automated systems where possible, and to individuals when desirable. Thus, a business may simply feed any checks and invoices it receives into the system and have the system automatically handle updating an automated accounting system, ensuring that checks are deposited quickly, and that invoices are scheduled for timely payment.

A SDIE will preferably have means for imaging documents, extracting data from the imaged documents, and making decisions based on the images and/or extracted data, and based on any such decisions, perform various functions such as routing or subsequent data processing. It should be noted that routing, imaging, and data extraction and other functions may be performed multiple times and in different orders.

It is contemplated that it may be advantageous for all or some of the SDIE functions be performed externally. As an example, a business may have all its mail routed to some other entity that handles imaging, decision making, and handling based on criteria previously provided by the business. Alternatively, a business may perform its own imaging via scanner or fax machine and forward document images to another entity for handling.

Imaging documents, whether done by the intended recipient of a document or an outside service provider, will typically be done by scanning a document to obtain an electronic image of the document. Any available means for imaging may be used, though those means that facilitate subsequent data extraction, routing, and storage are preferred. Such means may include specialized image clean-up/enhancement capabilities. Imaging may be performed in multiple steps, and the obtained images may be only transitory or may be stored for substantial periods of times. Thus, when a document is first received, a transitory image may be obtained via digital camera and/or scanner to determine initial routing of the document for subsequent handling. As an example, documents may be initially routed by size and shape so that subsequent imaging can be optimized. Subsequently or alternatively, a low resolution image may be used to pre-sort the documents by type such as by identifying photographs, letters, invoices, and/or checks. A final image step may be performed after initial routing to obtain a higher quality image if the document type/processing rules warrant it.

Routing of images will preferably be able to be based at least in part on recognition of the type of document received. Thus, a check would be recognized as being a check and handled accordingly, as would other documents such as letters, invoices, and e-mail messages. Recognition of a document's type may be based on or more of the following: physical characteristics such as size, shape, thickness, and color; graphical identifiers such as trademarks, watermarks, and barcodes; imbedded electronic identifiers; alphanumeric identifiers; recognition of non-alphanumeric features such as the positioning of form boxes; and/or analysis of data contained in the document.

Routing may be based in part on data extracted from a document either by itself or in combination with the type of the document. As and example, all correspondence, whether fax, e-mail, or letter or other form may be routed to an OCR server and/or free-form text data extraction tool. Alternatively, correspondence, to a business's legal department may be routed differently than correspondence routed to a business's accounting department.

It is contemplated that most of the functions of an SDIE be rules based to allow such a system to be adapted for the requirements of a particular business If the SDIE is being provided by an external service provider, such rules would be communicated to the external service provider.

As with imaging, extracting data from imaged documents may be done by any means, though means which properly balance speed with accuracy are preferred. Data extraction may occur at various points during processing. In many instances, documents will be routed to a data extraction server that is best suited to handle that particular document.

Different systems may utilize one or more off-the-shelf hardware and/or software products, and/or may utilize customized hardware and/or software.

It is contemplated that the use of an SDIE as described herein facilitates the automation of accounts payable (AP) processes. More particularly, an SDIE as described herein can be incorporated into an AP system that accepts standard AP documents, pays invoices that can be reconciled with other AP documents, and reports when documents cannot be reconciled.

The contemplated system will preferably accept purchase orders, shipping invoices, billing invoices, credit memos, and debit memos. The contemplated system will preferably extract one or more of the following from such documents: customer identifier (ID), location ID, vendor ID, form category/type, form/invoice number, item or services list/description, charge per item, total charge per form, date of shipment or service, date of automated data entry, entry source, and pages per entry. In some instances, data values will be assigned based on extracted data. The contemplated system will preferably reconcile the extracted and/or assigned data, will generate a month end statement, For reconciled invoices, payment will be accomplished via check or e-payment. Non-reconciled invoices will require manual review and instructions prior to payment.

It is contemplated that the SDIE and automated AP systems described herein facilitate a method of doing business wherein an AP processor accepts documents from a plurality of customers, submits those documents to automated AP processing, pays invoices on behalf of its customers, issues periodic billing statements to its customers, and notifies its customers of documents and/or transactions that could not be reconciled.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a schematic view of a first method embodying the invention.

FIG. 1B is a detailed schematic of an embodiment of the method of FIG. 1A.

FIG. 2A is a table of rules implemented in preferred APSs.

FIG. 2B is a table of reports implemented in preferred APSs.

FIG. 2C is a table of screens implemented in preferred APSs.

### DETAILED DESCRIPTION

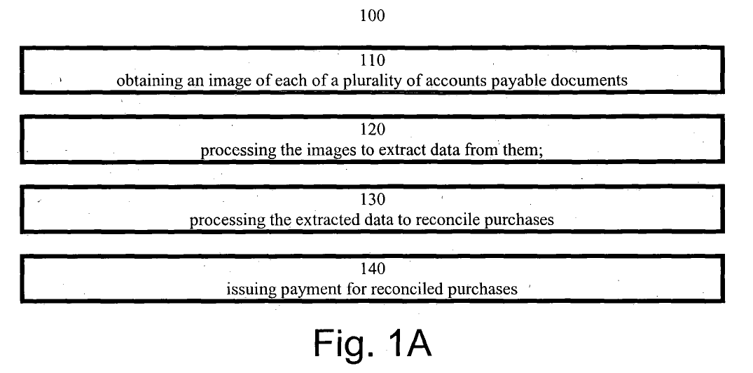

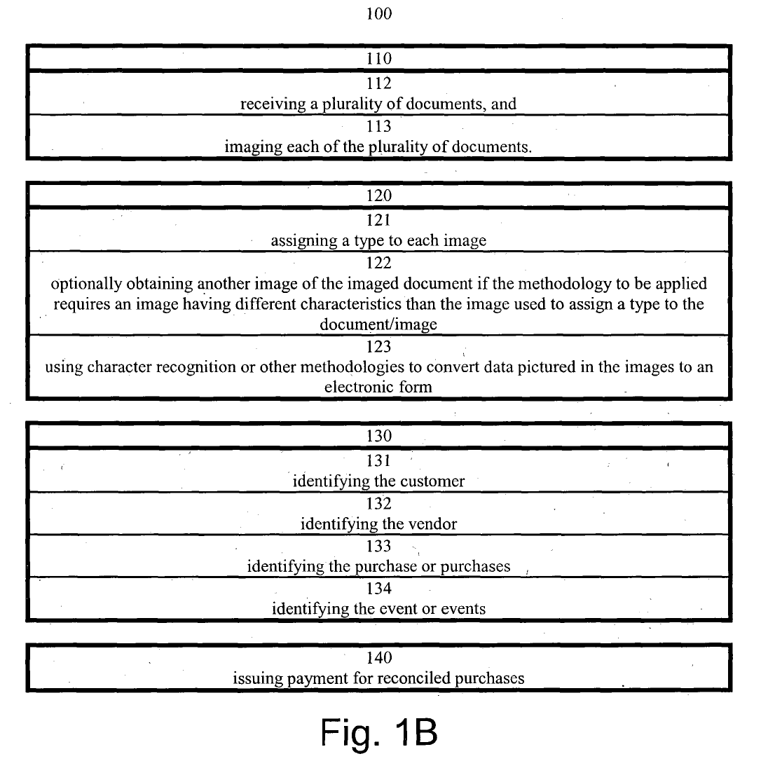

Referring to FIG. 1, a method 100 for automated accounts payable comprises the following: step 110, obtaining an image of each of a plurality of accounts payable documents; step 120, processing the images to extract data from them; step 130, processing the extracted data to reconcile purchases; and step 140, issuing payment for reconciled purchases. These steps may be performed by a single automated system, by multiple systems owned and operated by a single entity, and by multiple systems owned and operated by multiple entities. It is contemplated that in some instances it may be advantageous to have a first entity perform step 110, while a second entity performs step 130 and 140 with images and/or data gathered by the first entity being passed to the second entity for processing. Although all the steps herein are preferably automated, it is contemplated that in some instances manual methods may be employed to accomplish all or portions of a particular step.

Steps 110-140 are particularly directed to accounts payable. However, the method and systems described herein, particularly those relating to type based routing and processing are applicable to other, non-AP methods and systems as well.

Step 110 will generally comprise step 112, receiving a plurality of documents, and step 113, imaging each of the plurality of documents. It is contemplating that any method or system that provides a document image suitable for use in assigning a type to a document's image may be used. Such methods include, but are not limited to, scanning documents, taking digital photographs of documents, and microfilming documents (and preferably subsequently converting any microfilm images to electronic images). Documents may be imaged individually or in batches. Methods used may include specialized image clean-up/enhancement capabilities. Imaging may be performed in multiple steps, and the obtained images may be only transitory or may be stored for substantial periods of times.

Step 120 will generally comprise step 121, assigning a type to each image, and step 124, using character recognition or other methodologies to convert data pictured in the images to an electronic form. Step 120 may also comprise step 122, obtaining another image of the imaged document if the methodology to be applied requires an image having different characteristics than the image used to assign a type to the document/image. It is contemplated that assigning a type to each document image such that subsequent processing of the image can be tailored to its type will facilitate subsequent data extraction. Step 120 may also comprise step 123, routing the image based, at least in part, on its type prior to performing steps 130 and 140. Thus, a check would be recognized as being a check and handled accordingly, as would other documents such as letters, invoices, and e-mail messages.

Routing may be based in part on data extracted from a document either by itself or in combination with the type of the document. As an example, all correspondence, whether fax, e-mail, or letter or other form may be routed to an OCR server and/or free-form text data extraction tool. Alternatively, correspondence to a business's legal department may be routed differently than correspondence routed to a business's accounting department.

It is contemplated that systems and methods which can reliably distinguish between, purchase orders, shipping invoices, billing invoices, credit memos, and debit memos are particularly advantageous for accounts payable systems. It would also be advantageous if such systems could identify checks and other forms of received payment. Although identification and assignment of document types is preferably automated, in some instances type assignments may be done manually by individuals reviewing document images. In automated systems it is contemplated that documents types may reliably be determined by identifying one or more of the following: physical characteristics such as size, shape, thickness, and color; graphical identifiers such as trademarks, watermarks, and barcodes; imbedded electronic identifiers; alphanumeric identifiers; recognition of neon-alphanumeric features such as the positioning of form boxes; and/or analysis of data contained in the document. In preferred systems and methods, multiple characteristics will be used in combination to identify documents.

Step 130, processing the extracted data to reconcile purchases may comprise one or more of the following that the image relates to: step 131, identifying the customer; step 132, identifying the vendor; step 133, identifying the purchase and/or purchases; step 134, identifying the event (and/or events).

As with imaging, extracting data from imaged documents may be done by any means, though means which properly balance speed with accuracy are preferred. Data extraction may occur at various points during processing. In many instances, documents will be routed to a data extraction server that is best suited to handle that particular document.

It is contemplated that a service provider (AP Processor) could use an automated payroll system (APS) as described to provide accounts payable processing to a plurality of customers. In such an instance it is contemplated that a file or other form of dataset for each customer would be established as part of an AP Processor database (APP DB). Within the file would reside a folder representing each vendor from which an AP Processor customer (APP Customer) is known to purchase goods or services. Scanned payables type documents would be imaged, undergo optical character recognition (OCR) and the images assigned types based on forms recognition. Prior to imaging, documents could be delivered in standard fashion to an APP Customer, or alternatively may be delivered to an OCR service location. Critical information gathered from the payables type forms would be automatically measured and reconciled to a month-end billing statement to be provided to the APP Customer by the AP Processor. An order to pay would be generated by the AP Processor if all purchase orders, invoices, credits, and month-end billing statements reconciled. Items and/or transactions that could not be reconciled would be referred to an exception file for review by the APP Customer. The service provided by the AP Processor would be vendor independent although some customization may be required to handle forms that an APP Customer receives from a particular vendor.

In establishing a customer dataset/file for each APP Customer, it is contemplated that the AP Processor would include all relevant customer and vendor demographics as well as any needed account numbers/unique identifiers (ID's). In order to begin providing services to an APP Customer, the AP Processor will obtain sample payables forms from each APP Customer, and will provide such forms to a developer to modify the AP Processor's automated payroll system to handle such forms. In doing so, the AP Processor will generally specify those fields needed from each form, and the possible values of each field. The AP Processor will also provide rules, generally obtained from or approved by the APP Customer, that are to be used to determine a payment for purchases that have been reconciled for payment.

It is contemplated that the developer would in turn, (1) develop the AP Processor payables database; (2) create templates for mapping payable type documents; (3) OCR all forms for ID and data extraction; (4) develop data conversion from payable forms to the APP DB; (5) deliver converted data to the file of the APP Customer, and to the appropriate folder of the customer's vendor; (6) modify the APS such that data delivered to the APP DB will be categorized by form type, in particular types that designate a form or image as a purchase order, shipping invoice, billing invoice, credit memo, or debit memo. In some instances systems may be adapted to accept monthly reports from customers and to use those reports to verify the contents of the APP DB extracted from other documents.

It is contemplated that the APP DB will include at least some and possibly all of the following extracted or derived data items: (a) APP Customer ID, including location ID; (b) vendor ID; (c) form category/type; (d) form/invoice number; (e) item or services list/description; (f) charge per item; (g) total charge per form; (h) date of shipment or service; (i) date of entry to APP DB; (j) entry source; (k) pages per entry; (l) access security; and (m) levels of security.

All data submitted to the APP DB will be reconciled to the month end statement, when such a statement is available. All data fully reconciled will be made ready for payment, in accordance with one or more rules to be provided by the APP Customer. Payment for fully reconciled purchases may be made via APP Customer issued check, an e-payment manually approved by APP Customer, and/or an automatic e-payment. Purchases/items that do no not reconcile to month-end billing statement will be reported to APP Customer as an exception, and will require manual intervention.

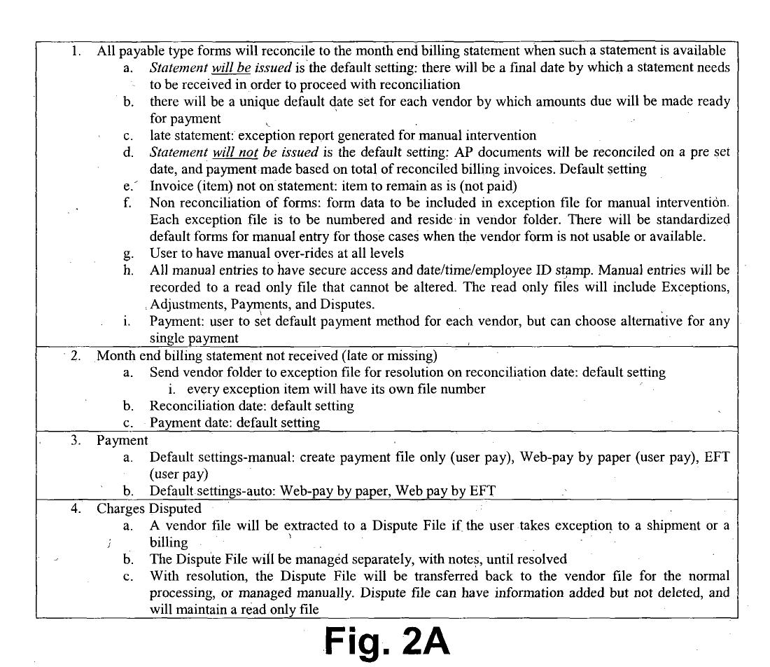

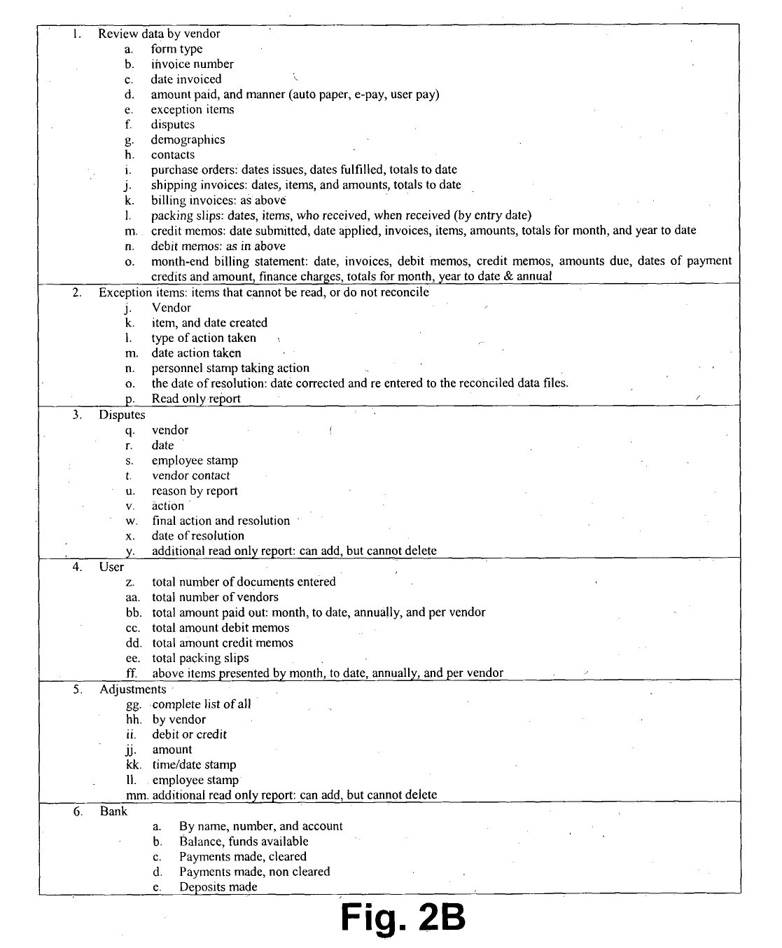

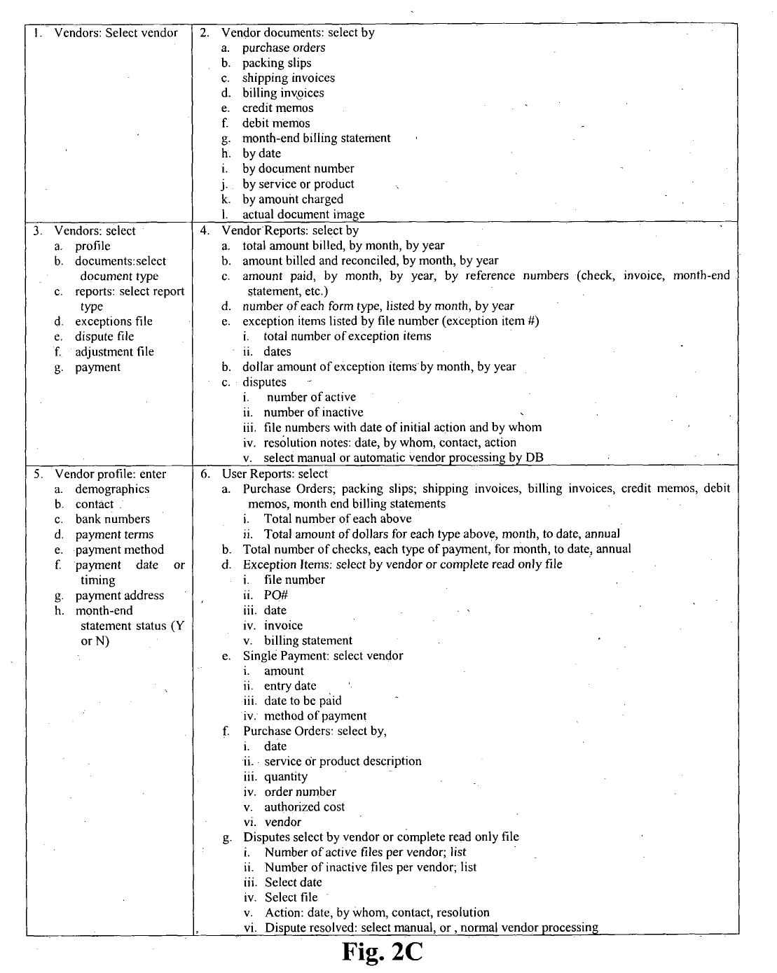

In addition to the features already described, it is contemplated that preferred APSs will implement one or more, and preferably all of the rules of FIG. 2A, the reports of FIG. 2B, the screens of FIG. 2C, and the features of FIG. 2D.

Thus, specific embodiments and applications of automated payment systems and methods, and SDIE systems and methods have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An automated accounts payable method comprising:
obtaining an image of each of a plurality of accounts payable documents;
processing the images to extract data from them;
processing the extracted data to reconcile purchases; and
issuing payment for reconciled purchases.

2. The method of claim 1 wherein processing the data to reconcile purchases comprises processing the extracted data to reconcile items billed for with items ordered and delivered.

3. The method of claim 2 wherein the accounts payable documents comprise at least one of each of a purchase order, a shipping invoice, and a billing invoice.

4. The method of claim 3 wherein the accounts payable documents comprise at least one of each of a credit memo and a debit memo.

5. The method of claim 4 further comprising generating a report of non-reconciled events.

6. The method of claim 5 wherein issuing payment comprises printing a check.

7. The method of claim 1 wherein the images of each of at least two documents are part of an image showing all of the at least two documents.

8. An accounts payable data collection system comprising:
a mechanism adapted to assign a type from a set of types to each of a plurality of images, wherein the plurality of images comprises images of accounts payable documents;
a first unit adapted to process images of a first type;
a second unit adapted to process images of a second type wherein the second type is not the first type;
a routing unit adapted to route images assigned the first type to the first processing unit and images assigned the second type to the second processing unit.

9. The system of claim 8 wherein the images comprise images of at least two of the following: purchase orders, shipping invoices, billing invoices, credit memos, and debit memos.

10. The system of claim 9 further comprising a unit adapted to accept documents for imaging and to obtain the plurality of images by obtaining images of any accepted documents.

11 The system of claim 10 further comprising a document sorting unit adapted to sort received documents based on the types assigned to the document images.

12. The system of claim 11 further comprising a document marking unit adapted to mark each of the received documents with a mark corresponding to the type assigned to an image of the document.

13. A method of data collection comprising obtaining an image of a document, assigning a type to the image, and processing the image based on the type assigned to it.

14. The method of claim 13 wherein the type assigned is determined at least in part by the dimensions of the document.

15. The method of claim 13 wherein the type assigned is determined at least by identifying a trademark that is part of the image.

16. The method of claim 13 comprising obtaining images of a plurality of documents, assigning a type to each of the plurality of images, and processing each of the plurality of images based on the type assigned to it.

17. The method of claim 16 wherein the plurality of documents comprise at least some checks and at least some invoices, and processing each of the plurality of images results in an automated accounting system being updated to include data obtained from each of the at least some checks and at least some invoices.

18. The method of claim 17 wherein a single check type is assigned to each image of a plurality of images of received checks, and the check type is assigned at least in part based on dimensions of the document being imaged.

19. The method of claim 18 wherein the check type is assigned at least in part based on identifying portions of the image that likely correspond to at least some of the following:
a check number, a bar code, the text “pay to the order of”, a signature, a payee, a date, and a payment amount.

20. The method of claim 19 wherein the value of a portion of the bar code is determined to correspond to a value used to identify a known financial institution as part of the process of assigning a type to the document image.

21. The method of claim 16 wherein processing each of the plurality of images comprises obtaining at least one additional image of the document for at least some document types.
